(19) United States
(12) Patent Application Publication
(10) Pub. No.: US 2007/0071288 A1
(43) Pub. Date: Mar. 29, 2007

(54) Facial features based human face recognition method

(76) Inventors: Quen-Zong Wu, Taoyuan (TW); Heng-Sung Liu, Taoyuan (TW); Chia-Jung Pai, Taoyuan (TW)

Correspondence Address: RABIN & BERDO, P. C., Suite 500, 1101 14 St., N. W., Washington, DC, 20005, US

(21) Appl. No.: 11/237,706

(22) Filed: Sep. 29, 2005

(51) Int. Cl. G06K 9/00

(52) U.S. Cl. 382/118

(57) ABSTRACT

A method of facial features based human face recognition is disclosed. A human face and facial features thereof with respect to an input image corresponding to a person are first detected person by person by image processing technology. Then, each of such facial features for a plurality of persons are categorized into several categories and expressed to form a human facial features database for the plurality of persons. A to-be-searched or recognized human face image of a person is inputted. Then, the image is acquired with positions of the person's face and facial features by image processing technology and each of the facial features is categorized into several categories each with a specific expression. Then, according to the categories which the facial features of the person belongs to, the person may be recognized. As such, the purposes of human face search and recognition are achieved.

### BACKGROUND OF THE INVENTION

1. Field of the Invention

The present invention relates to a method of facial features based human face recognition through which positions of a human face and facial features thereof may be automatically detected and the facial features may be categorized by using image processing technology, which may be widely used in face search and recognition.

2. Description of the Prior Art

For the bio features authentication systems or human face recognition systems, image processing technology is generally applied to achieve the human face recognition function. In those systems, a human face image database should be established previously, which is waste of time, and an objective human face is compared with human faces stored in the database. However, since the comparison process is waste of time and resource, and no any visual expression with respect to an identified person are made previously. It is difficult to determine whether the objective human face is the same to one of the image information batches stored in the databases for a human being. In addition, there is no method existing to describe human facial features. In view of this, the conventional systems are not user-friendly to users and needed to be improved.

From the above discussion, it can be readily known that some drawbacks are inherent in such conventional bio features authentication systems or human face recognition systems and need to be addressed and improved.

In view of these problems encountered in the prior art, the Inventors have paid many efforts in the related research and finally developed successfully a method of facial features based human face recognition which may be implemented in bio features authentication systems or human face recognition systems. In this method, human facial features may be detected by using image processing technology and categorized. Further, the method provides a reasonable and good human facial description manner.

### SUMMARY OF THE INVENTION

It is, therefore, an object of the present invention to provide a method of facial features based human face recognition which may improve the prior art, bio features authentication systems and human face recognition systems, and provide a reasonable and practicable solution to describe human faces.

Since the conventional human face recognition system or bio features authentication system is provided for recognition or authentication of human beings or organisms and thus has a different facial features description manner as compared to that generally used. A user may think the previous system is not intuitive and not friendly, and the system may not be readily used in real environment. To overcome the disadvantages of the prior art system, a method of facial features based face recognition is set forth in the present invention.

The inventive system is mainly composed of a human face detection unit and a human facial features description unit. An human face image is inputted into the human face detection unit and processed by a human face detection algorithm, through which a portion of the person where the human face is located is acquired and positions of his/her human face features, such as eyes, nostrils, ears and mouth, are detected.

The human facial features description unit has categories defined for each of the facial features. For example, eyes may have the categories of small eyes, big eyes and single eye and mouth may have the categories of small mouth, big mouth and mouth of thick lips.

With the inventive features expression method, the current bio features authentication system and human face recognition system may define sufficient and reasonable categories for each of the human facial features. With these categories, not only authentication function but also a more proper description manner of human facial features may be achieved in the system. Further, a possible object may be effectively located when a habitually practiced oral description manner of human beings is inputted. Therefore, the inventive method possesses an improved usage and communication interface.

These features and advantages of the present invention will be fully understood and appreciated from the following detailed description of the accompanying drawings.

### BRIEF DESCRIPTION OF THE DRAWINGS

The drawings disclose an illustrative embodiment of the present invention which serves to exemplify the various advantages and objects hereof, and are as follows:

FIG. 1 is an architecture diagram of the system, on which a method of facial features based human face recognition according to an embodiment of the present invention is performed;

FIG. 2A˜FIG. 2H is human facial features diagram illustrating the method of facial features based human face recognition according to the embodiment of the present invention;

FIG. 3A˜FIG. 3F is a schematic diagram of categories of mouth according to the present invention; and

FIG. 4 is a schematic diagram of a combination of various classifiers according to the present invention.

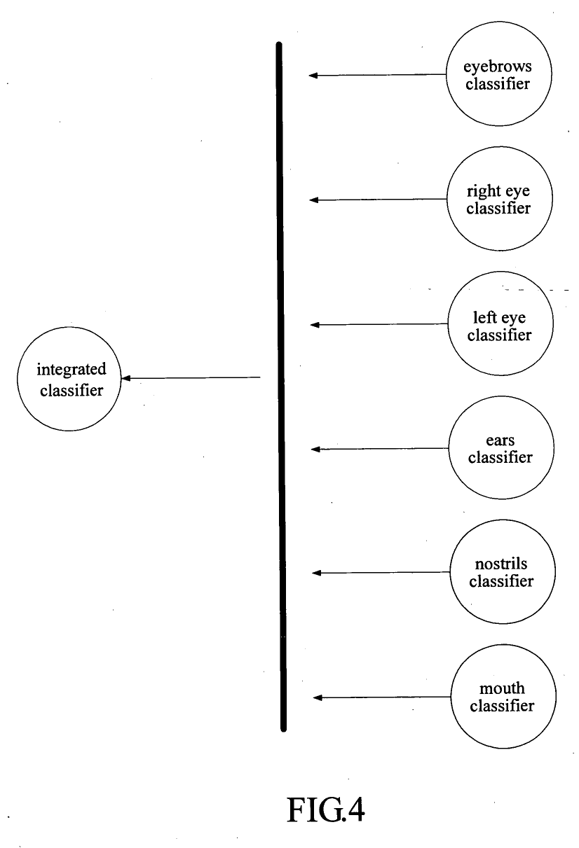

### DETAILED DESCRIPTION OF THE PREFERRED EMBODIMENT

According to the present invention, a method of facial features based human face recognition, which is used to recognize an input human face image corresponding to a person, is set forth and characterized in that positions of a human face and all the facial features of the human face are detected by a human face detection unit and each of the facial features is categorized into one of a plurality of categories with respect to the facial feature by a human facial features description unit. Each of the facial features has its pre-defined expression, so that the input human face image is recognized in terms of each of the facial features thereof, and the determined category of each facial feature is compared to those of all persons stored in a database. The database obtained in the same way as that for the person has the determined category for each of the facial features for a plurality of persons, and the person can be identified by matching with people in the database.

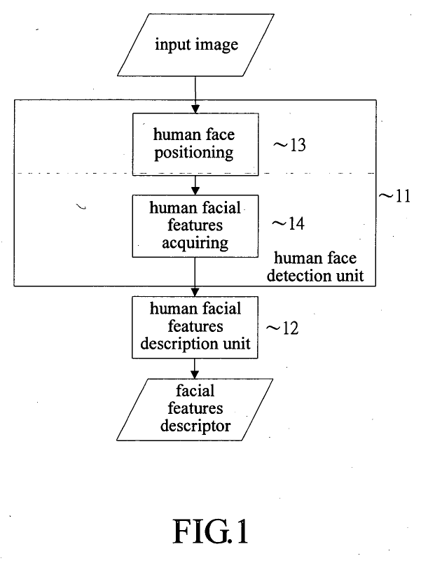

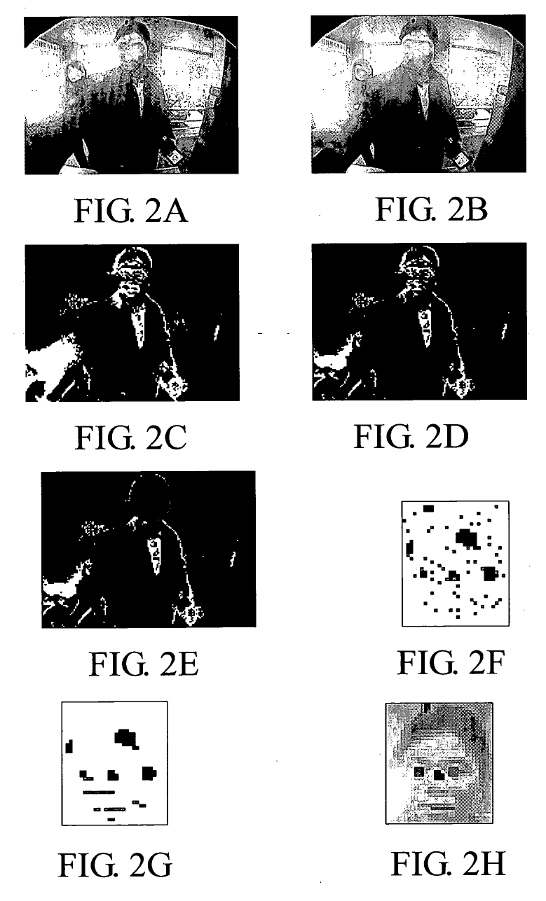

Referring to FIG. 1 and FIG. 2A˜FIG. 2H, an architecture diagram of the system, on which the method of facial features based human face recognition is performed, and an exemplary case of the method according to a preferred embodiment of the present invention are shown therein, respectively. At first, a human face image is inputted to a human face detection unit 11. As an example, the inputted image, two consecutively taken photographs, is shown in FIG. 2A and FIG. 2B, respectively. In the human face detection unit 11, a human face positioning sub-unit 13 and a human facial features acquiring sub-unit 14 are comprised. The human face positioning sub-unit 13 is used to determine a contour of an object to be detected by using moving object detection and edge image detection methods, shown in FIG. 2C and FIG. 2D. Then, ellipse positioning and skin tone detection algorithms are used to detect the position of the human face, shown in FIG. 2E. The human face features acquiring unit 14 is used to detect facial features to be categorized, such as eyes, nostrils, ears and mouth. Each human facial feature is categorized into several categories previously defined. Hereinbelow, only eyes and mouth are explained in terms of position detection as examples by using an eyes mask depicted in the following. As such, a possible position of the eyes or mouth may be located.

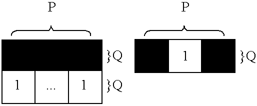

The first mask has a dimension of P×2 Q and is used to locate a center point having a darker rectangular block above and a brighter rectangular block below. The second mask has a dimension of P×Q and is used to locate a center point having a brighter rectangular block central to the center point and two rectangular blocks at both sides of the center point. If the two mask operation results are both greater than a threshold ρ at the same bit point, then the bit point is considered as a center position of the eyes. For this reason, the two masks are named as eyes' center masks. When the eyes' center position is located, the position of the eyes has to be further confirmed. Since many candidate points are presented, the exact positions of the eyes and their centers are needed to be located further. At this time, local minimums on horizontal and vertical lines are taken from the human face area, and the minimums on the horizontal and vertical lines are AND-ed so as to obtain several candidate points. By using connected component labeling method, the located positions of the eyes are divided into several blocks of eyes' center. Then, eyes match is conducted over two sides of each of the block. The eyes match is done when the following three conditions are met. 1. The position of the center of the matched eyes has to fall on the block of eyes' center. 2. The matched eyes have to have similar averages values of gray level. 3. Tilt angle of the matched eyes has to be within an acceptable range. Since many eyes may be still matched according to the above three conditions, the final matched eyes have the minimum distance but greater than a threshold ρ. As such, the position of the matched eyes is located by means of the block of eyes' center. Finally, a block with matched eyes which is closest to the center of face is determined as the proper block of eyes' center. In FIG. 2F, a black block is the possible block of eye's center and a grey point is a local minimum.

To locate a position of mouth, the block of eyes' center is also used since the position of mouth is absolutely below the block of eye's center. Like the case of eyes, a local minimum for each vertical line is taken on the face block (local minimums for horizontal lines are not required). Then, connected lines of local minimums greater than 2 in length is located below each block of eye's center. Since such connected lines may possibly be the mouth, the position of the mouth may be located as a proper one among the connected lines by referring to the distances between the eyes and between the center of the eyes and the mouth since the eyes has been detected. FIG. 2G shows all connected lines of local minimums below the block of eyes' center. FIG. 2H shows grey points as the position of the eyes and mouth located in this example.

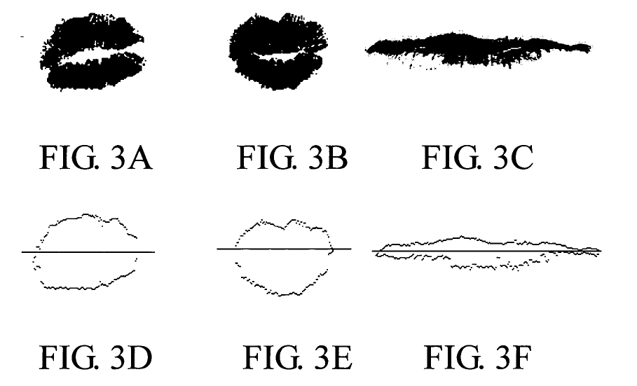

The human facial features description unit 12 categorizes the detected human facial features. For example, eyes may be categorized into big eyes, small eyes and single eye and mouth may be categorized into small mouth and big mouth. Then, the detected features are compared to these categories and thus categorized into some categories. It is important to categorize the facial features based on necessity. Thus, difference between and usability of various facial features have to be calculated. Then, whether the categorization of the facial features is proper should be determined from its usability value. This will be described with mouth as an example. FIG. 3A, FIG. 3B and FIG. 3C show mouth of three categories, respectively. A proportional difference Dr may be defined as a ratio of a maximum and a minimum of each two categories of the facial feature.
Dr=MAX(W1/H1, W2/H2)/MIN(W1/H1, W2/H2),
wherein Wi is a width of mouth of an i-th category, Hi is a height of the i-th category, MAX(A,B) is a maximum between A and B and MIN (A,B) is a minimum between A and B.

FIG. 3D, FIG. 3E and FIG. 3F show diagrams of contours and center lines of the mouth of the categories A, B and C. A contour difference Dc may be defined as a difference of
D_{c}=|Σᵢ|H₁ᵢ−center₁|−Σⱼ|H₂ⱼ−center₂||/Sum,
where H1i and H2j are an upper bound or a lower bound of two categories' contour, respectively, center1 and center2 are positions of the center lines of two categories' contour and Sum is a total point number of two contours. With the Dr and Dc obtained, a total difference Dt may be defined as:
D^{t}=Dᵣ×D_{c}

The total difference may be used not only to determine which category the detected feature belongs to but also determine usability of the facial feature based on the following equation:
U=MIN({Dt}),
wherein {Dt} is a group formed of values of total difference Dt between each two categories. From the definition, a total difference Dt with a lowest difference value may be obtained, and whether the categorization manner has a sufficient usability may be determined. If the value is large, difference between each two categories for the facial feature is large. If the value is small, difference of at least two categories of the facial features is small. Besides the method described above, neutral network and principle component analysis methods are also practicable for categorization.

In addition to each being categorized into several categories, the individual facial features may also be integrated into a large classifier. Or, each two facial features may be integrated into a middle classifier. For example, although only two facial features are utilized for categorization, 100 different categories may be obtained to recognize if each of the eyes and mouth is categorized into 10 categories. In case that other facial features are introduced for reference, the ability to categorization may be largely enhanced. Therefore, the inventive method may also be used in systems for various recognition.

As compared to the prior art, the facial features based human face recognition method of this invention provides at least the following advantages. 1. An intuitive and friendly facial features description manner may be provided. 2. The method may be used in a bio features authentication system and a human face recognition system. 3. Facial features description and recognition functions may be properly integrated efficiently.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method of facial features based human face recognition used to recognize an input human face image corresponding to a person, said method being characterized in that positions of a human face and each of facial features of the human face is detected by a human face detection unit and each of the facial features are categorized into one of a plurality of categories with respect to the facial feature by a human facial
features description unit so that the input human face image is recognized by image processing technology in terms of each of the facial features thereof and the determined category for each of the facial features is compared to categories for each facial feature of all persons stored in a database to see who the person is in the database.

2. The method according to claim 1, wherein the human face detection unit detects the positions of the human face by moving object detection and edge image detection methods.

3. The method according to claim 1, wherein the human face detection unit detects the facial feature eyes by a center block of eyes and a local minimum.

4. The method according to claim 1, wherein the human face detection unit detects the facial feature mouth by a center block of eyes and a local minimum.

5. The method according to claim 1, wherein the human face detection unit is capable of detection of eyebrows, eyes, nostrils, ears and mouth.

6. The method according to claim 1, wherein the human facial features description unit performs the facial features categorization by detecting a contour of the facial feature and the facial features categorization or the human face recognition by defining a reasonable difference formula.

7. The method according to claim 1, wherein the human facial features description unit categorizes the facial feature by using neural network.

8. The method according to claim 1, wherein the human facial features description categorizes the facial feature by using element analysis method.

9. The method according to claim 1, wherein each of the facial features used in the human facial features description unit is used individually as a classifier or for human face recognition or used together with another of, a plurality of or all of the facial features as a classifier or for human face recognition.

10. The method according to claim 9, wherein a relationship between each two of the facial features used in the human facial features description unit is used as a reference of the classifier.

11. The method according to claim 1, wherein the database has the determined category for each of the facial features for a plurality of persons, obtained in the same way as that for the person, stored therein, the determined category having its pre-defined description.
